(19) United States
(12) Patent Application Publication
(10) Pub. No.: US 2018/0104667 A1
(43) Pub. Date: Apr. 19, 2018

(54) SORBENT BLEND COMPOSITIONS FOR MERCURY REMOVAL FROM FLUE GASES

(71) Applicant: Cabot Corporation, Boston, MA (US)

(72) Inventors: Mei Xin, North Billerica, MA (US); Gerald D. Adler, Charlestown, MA (US)

(21) Appl. No.: 15/568,226

(22) PCT Filed: Apr. 27, 2016
(86) PCT No.: PCT/US2016/029497

§ 371 Date: Oct. 20, 2017

Related U.S. Application Data
(60) Provisional application No. 62/174,136, filed on Jun. 11, 2015.
(60) Provisional application No. 62/154,964, filed on Apr. 30, 2015.

(51) Int. Cl. B01J 20/04; B01J 20/20; B01J 20/28; B01D 53/02; B01D 53/30; B01D 53/64; B01D 53/81

(52) U.S. Cl. CPC B01J 20/041; B01D 2258/0283; B01J 20/28004; B01J 20/28059; B01J 20/28071; B01D 53/02; B01D 53/30; B01D 53/64; B01D 53/81; B01J 2220/42; B01D 2251/404; B01D 2251/604; B01D 2253/102; B01D 2253/304; B01D 2257/602; B01J 20/20

(57) ABSTRACT

Disclosed herein are dry blend compositions comprising: a hydrated lime having a Ca(OH)₂ content of at least 94% by weight, the hydrated lime being present in an amount ranging from 1% to 40% by weight relative to the total weight of the composition; and an activated carbon present in an amount of at least 60% by weight relative to the total weight of the composition. Also disclosed are methods of mercury removal from flue gases, such as flue gases generated from coal-fired power plants.

### FIELD OF THE INVENTION

Disclosed herein are dry blends comprising activated carbon and hydrated lime. The dry blends can be used as sorbents for mercury removal, e.g., from flue gases generated from coal-fired power plants.

### BACKGROUND

Mercury is a regulated contaminant in process/discharge gases of a number of industrial operations (e.g., power plants, incinerators, and concrete kilns). Mercury may be removed from these gases by sorbents, which can be carbon or non-carbon based. While much development has focused on improved mercury removal, more stringent federal mercury compliance standards are likely forthcoming. Accordingly, there remains a constant need for developing sorbents for mercury removal.

### SUMMARY

One embodiment provides a dry blend composition comprising:

a hydrated lime having a Ca(OH)₂ content of at least 94% by weight, the hydrated lime being present in an amount ranging from 1% to 40% by weight relative to the total weight of the composition; and

an activated carbon present in an amount of at least 60% by weight relative to the total weight of the composition.

Another embodiment provides a method of mercury removal from a flue gas, comprising:

adding a dry blend sorbent composition to a flue gas, the composition comprising:
a hydrated lime having a Ca(OH)₂ content of at least 94% by weight, the hydrated lime being present in an amount ranging from 1% to 40% by weight relative to the total weight of the composition; and
an activated carbon present in an amount of at least 60% by weight relative to the total weight of the composition.

Another embodiment provides a method of mercury removal from a flue gas, comprising:

adding activated carbon and a hydrated lime to a flue gas,

wherein the hydrated lime has a Ca(OH)₂ content of at least 94% by weight, and

wherein a mass ratio of activated carbon to hydrated lime added to the flue gas ranges from 6:4 to 95:5.

Another embodiment provides a method of mercury removal from a flue gas, comprising:

determining an SO₃ concentration in the flue gas; and

adding a sorbent to the flue gas, wherein the sorbent comprises activated carbon and hydrated lime having a Ca(OH)₂ content of at least 94% by weight, and

wherein for an SO₃ concentration greater than 1 ppm, a mass ratio of activated carbon to hydrated lime added to the flue gas ranges from 6:4 to 8:2, and

wherein for SO₃ concentration less than 1 ppm, a mass ratio of activated carbon to hydrated lime added to the flue gas ranges from 7:3 to 95:5.

Another embodiment provides a method of mercury removal from a flue gas, comprising:

determining an SO₃ concentration in the flue gas; and

adding a sorbent to the flue gas, wherein the sorbent comprises activated carbon and hydrated lime having a Ca(OH)₂ content of at least 94% by weight, and

wherein for an SO₃ concentration greater than 3 ppm, a mass ratio of activated carbon to hydrated lime added to the flue gas ranges from 6:4 to 8:2, and

wherein for SO₃ concentration less than 3 ppm, a mass ratio of activated carbon to hydrated lime added to the flue gas ranges from 7:3 to 95:5.

Another embodiment provides a method of mercury removal from a flue gas, comprising:

determining an SO₃ concentration in the flue gas; and

adding a sorbent to the flue gas, wherein the sorbent comprises activated carbon and hydrated lime having a Ca(OH)₂ content of at least 94% by weight, and

wherein for an SO₃ concentration greater than 5 ppm, a mass ratio of activated carbon to hydrated lime added to the flue gas ranges from 6:4 to 8:2, and

wherein for SO₃ concentration less than 5 ppm, a mass ratio of activated carbon to hydrated lime added to the flue gas ranges from 7:3 to 95:5.

### BRIEF DESCRIPTION OF THE DRAWING(S)

FIG. 1 is a flow chart illustrating a basic configuration of a coal-fired power plant including the pathway of the flue gas upon coal combustion;

FIG. 2 is a flow chart of a coal-fired power plant with a slipstream;

FIG. 3 is a plot of baseline adjusted Hg removal versus sorbent injection rate [lb/MMacf] for the activated carbon/lime blends of Example 2;

FIG. 4 is a plot of baseline adjusted Hg removal versus sorbent injection rate [lb/MMacf] for the activated carbon/lime blends of Example 3;

FIG. 5 is a plot of baseline adjusted Hg removal versus sorbent injection rate [lb/MMacf] for the activated carbon/lime blends of Example 4; and

FIG. 6 is a plot of baseline adjusted Hg removal versus sorbent injection rate [lb/MMacf] for the 60:40 activated carbon:hydrated lime blend of Example 4.

### DETAILED DESCRIPTION

Disclosed herein are dry blends comprising activated carbon and hydrated lime, in which the hydrated lime has a Ca(OH)₂ content of at least 94% by weight.

Activated carbons are known sorbents for removing mercury impurities present in flue gases, such as flue gases generated from coal-fired industrial operations, such as power plants. Mercury removal or mercury adsorption is understood as removing or adsorbing elemental or ionic forms of mercury. The effectiveness of mercury removal, however, can be impacted by the presence of other impurities such as SO₃. SO₃ can compete with mercury impurities for adsorption sites on the activated carbon, effectively reducing the number of sites for mercury adsorption and consequently reducing the mercury removal efficiency. The SO₃ concentration can vary depending on the flue gas streams or conditioning of particulate removal equipment in which higher concentration of SO₃ coupled with the ability of SO₃ to competitively bind to activated carbon can present a challenge for mercury removal.

It has been previously demonstrated that SO₃ can react with certain alkali-based sorbents, with the result that the activated carbon surface has a greater number of available sites for mercury adsorption. However, such alkali-based sorbents were thought to be effective when present as a majority component in the sorbent composition, or provided as a composite with a carbonaceous sorbent. It has been discovered that the use of a dry blend comprising a hydrated lime having a Ca(OH)₂ content of at least 94% by weight in combination with activated carbon as a majority component results in a mercury removal performance that equals or in some cases surpasses the performance of activated carbon alone. Accordingly, one embodiment provides a dry blend composition comprising, or consisting essentially of, or consisting of:

a hydrated lime having a Ca(OH)₂ content of at least 94% by weight, the hydrated lime being present in an amount ranging from 1% to 40% by weight relative to the total weight of the composition; and

an activated carbon present in an amount of at least 60% by weight relative to the total weight of the composition.

Lime-based sorbents have been used in the removal of SO₃ from flue gases, as well as other impurities such as HCl, SO₂ and H₂S. Different types of limes exist and are distinguished from each other based on factors such as the type and content of calcium and magnesium (e.g., CaCO₃, Ca(OH)₂, CaO, MgO, Mg(OH)₂), or by specific gravity, bulk density, among other properties. For example, quicklimes are composed of primarily CaO, whereas hydrated limes comprise primarily Ca(OH)₂ as the result of adding water to quicklime. Limestone contains primarily CaCO₃. Certain hydrated limes, e.g., dolomitic limes, contain a significant amount of MgO or Mg(OH)₂.

In one embodiment, the hydrated limes used herein have a Ca(OH)₂ concentration of at least 94% by weight and have an MgO concentration of less than 5% by weight, or less than 3% by weight. In another embodiment, the hydrated limes have a Ca(OH)₂ concentration of at least 94% by weight and an Mg(OH)₂ concentration of less than 5% by weight, or less than 3% by weight. In yet another embodiment, the hydrated limes have a Ca(OH)₂ concentration of at least 94% by weight, an MgO concentration of less than 5% by weight (or less than 3% by weight), and an Mg(OH)₂ concentration of less than 5% by weight (or less than 3% by weight).

Activated carbon is typically prepared by carbonizing/activating a raw material that can function as a carbonaceous source. The activation may occur separately or concurrently, e.g., via steam, gas, and/or chemical treatment at high temperature, such as in a kiln. For example, a raw material can be dried (e.g., under heat) to remove volatiles, followed by activation with steam. Steam diffuses into cracks of the material and the resulting gasification reactions increase the pore volume of the material. In one embodiment, useful activated carbons can be any obtained from raw materials selected from peat, wood, lignocellulosic materials, biomass, waste, tire, olive pits, peach pits, corn hulls, rice hulls, petroleum coke, lignite, brown coal, anthracite coal, bituminous coal, sub-bituminous coal, coconut shells, pecan shells, and walnut shells, and other raw materials known in the art. In one embodiment, the activated carbons disclosed herein are lignite-based activated carbons or bituminous coal-based activated carbons (e.g., derived from lignite or bituminous coal). In one embodiment, the activated carbons disclosed herein are lignite-based activated carbons.

Useful activated carbons for mercury removal can be carbonaceous or halogenated. Flue gas can contain mercury contaminants in both elemental and oxidized forms. The halogen (e.g., fluorine, chlorine, bromine, or iodine) can aid in oxidizing elemental mercury to the more readily adsorbed oxidized form, which can then adsorb onto the activated carbon surface. In one embodiment, the halogen can be selected from bromine. In one embodiment, the amount of halogen (e.g., bromine) ranges from 1% to 5% by weight, relative to the weight of the activated carbon. Bromination can be performed by a number of methods known in the art, e.g., as described in U.S. Pat. No. 8,551,431, the disclosure of which is incorporated herein by reference. Exemplary halogenated activated carbons include those sold as DARCO® Hg-LH EXTRA activated carbon, commercially available from Cabot Corporation.

A “dry blend” as used herein refers to a physical mixture of activated carbon (either halogenated or unhalogenated) and hydrated lime; no additional water is added. In one embodiment, the dry blend consists essentially of or consists of activated carbon and hydrated lime. In one embodiment, the tamped density of the dry blend is an arithmetic combination of the two constituent tamped densities based on the relative percentage of each component. In one embodiment, the tamped density ranges from 30 lb/ft³ to 55 lb/ft³, e.g., from 35 lb/ft³ to 55 lb/ft³, from 40 lb/ft³ to 55 lb/ft³, from 30 lb/ft³ to 50 lb/ft³, from 35 lb/ft³ to 50 lb/ft³, from 40 lb/ft³ to 50 lb/ft³, from 30 lb/ft³ to 45 lb/ft³, from 35 lb/ft³ to 45 lb/ft³, or from 40 lb/ft³ to 45 lb/ft³.

The activated carbon and hydrated lime can be mixed by any method known in the art, e.g., with mixers (e.g., powder mixers), dispersers, drums, blenders, tumblers. As a result, the dry blend comprises a mixture of homogeneously interspersed particles of activated carbon and hydrated lime.

In one embodiment, the hydrated lime is present in the dry blend composition in an amount ranging from 1% to 40% by weight (e.g., from 5% to 40% by weight, from 10% to 40% by weight, from 15% to 40% by weight, or from 20% to 40% by weight) and the activated carbon (either halogenated or unhalogenated) is present in an amount of at least 60% by weight (e.g., from 60% to 99%, from 60% to 95%, from 60% to 90%, from 60% to 85%, or from 60% to 80% by weight), relative to the total weight of the composition. In another embodiment, the hydrated lime is present in the dry blend composition in an amount ranging from 1% to 30% by weight (e.g., from 5% to 30% by weight, from 10% to 30% by weight, from 15% to 30% by weight, or from 20% to 30% by weight) and the activated carbon is present in an amount of at least 70% by weight (e.g., from 70% to 99%, from 70% to 95%, from 70% to 90%, from 70% to 85%, or from 70% to 80% by weight), relative to the total weight of the composition. In yet another embodiment, the hydrated lime is present in the dry blend composition in an amount ranging from 1% to 25% by weight (e.g., from 5% to 25% by weight, from 10% to 25% by weight, from 15% to 25% by weight, or from 20% to 25% by weight) and the activated carbon is present in an amount of at least 75% by weight (e.g., from 75% to 99%, from 75% to 95%, from 75% to 90%, from 75% to 85%, or from 75% to 80% by weight), relative to the total weight of the composition.

In one embodiment, the dry blend comprises, consists essentially of, or consists of hydrated lime present in the dry blend composition in an amount ranging from 5% to 40% by weight and activated carbon present in an amount ranging from 60% to 95% by weight. In one embodiment, the dry blend comprises, consists essentially of, or consists of hydrated lime present in the dry blend composition in an amount ranging from 5% to 30% by weight and activated carbon present in an amount ranging from 70% to 95% by weight. In one embodiment, the dry blend comprises, consists essentially of, or consists of hydrated lime present in the dry blend composition in an amount ranging from 5% to 25% by weight and activated carbon present in an amount ranging from 75% to 95% by weight. In one embodiment, the dry blend comprises, consists essentially of, or consists of hydrated lime present in the dry blend composition in an amount ranging from 10% to 40% by weight and activated carbon present in an amount ranging from 60% to 90% by weight. In one embodiment, the dry blend comprises, consists essentially of, or consists of hydrated lime present in the dry blend composition in an amount ranging from 10% to 30% by weight and activated carbon present in an amount ranging from 70% to 90% by weight. In one embodiment, the dry blend comprises, consists essentially of, or consists of hydrated lime present in the dry blend composition in an amount ranging from 10% to 25% by weight and activated carbon present in an amount ranging from 75% to 90% by weight.

In one embodiment, a ratio of activated carbon to hydrated lime ranges from 6:4 to 95:5 in which the hydrated lime is present in the dry blend composition in an amount ranging from 5% to 40% by weight, from 10% to 40% by weight, from 15% to 40% by weight, or from 20% to 40% by weight, 5% to 30% by weight. In another embodiment, a ratio of activated carbon to hydrated lime ranges from 6:4 to 9:1, from 6:4 to 8:2, from 7:3 to 9:1, or from 7:3 to 8:2.

In general, the hydrated limes disclosed herein have a particle size substantially smaller than that of the activated carbon. Without wishing to be bound by any theory, it is believed that in addition to reacting with SO₃ and other species that may compete with mercury for activated carbon binding sites, the addition of lime effectively increases the overall surface area of the blend. In one embodiment, the hydrated limes disclosed herein have a d₅₀ particle size distribution ranging from 1-10 μm, e.g., a d₅₀ particle size distribution ranging from 1-6 μm, from 1-5 μm, from 2-6 μm, from 2-5 μm, or a d₅₀ particle size distribution ranging from 2-4 μm.

In one embodiment, the composition comprising the hydrated limes further comprise the activated carbon having a d₅₀ particle size distribution ranging from 7-30 μm, e.g., from 7-25 μm, from 10-30 μm, or from 10-25 μm. Particle size distributions for activated carbon can be measured according to any method known in the art, e.g., with an LS™ 13 320 or an LS™ 200 Laser Diffraction Particle Size Analyzer, both available from Beckman Coulter.

In one embodiment, the hydrated lime has a surface area (e.g., N₂ BET surface area) of at least 20 m²/g, e.g., a surface area ranging from 20 m²/g to 40 m²/g, from 20 m²/g to 35 m²/g, from 20 m²/g to 30 m²/g, or from 20 m²/g to 25 m²/g.

In one embodiment, internal surface area significantly contributes to the overall lime surface area, as indicate by nitrogen adsorption and mercury intrusion porosimetry. In one embodiment, the hydrated lime has a pore volume of at least 0.06 m³/g, at least 0.07 m³/g, or at least 0.08 m³/g, e.g., a pore volume ranging from 0.06 m³/g to 0.3 m³/g, from 0.06 m³/g to 0.25 m³/g, from 0.06 m³/g to 0.2 m³/g, 0.06 m³/g to 0.15 m³/g, from 0.06 m³/g to 0.1 m³/g, from 0.07 m³/g to 0.3 m³/g, from 0.07 m³/g to 0.25 m³/g, from 0.07 m³/g to 0.2 m³/g, 0.07 m³/g to 0.15 m³/g, from 0.07 m³/g to 0.1 m³/g, from 0.08 m³/g to 0.3 m³/g, from 0.08 m³/g to 0.25 m³/g, from 0.08 m³/g to 0.2 m³/g, from 0.08 m³/g to 0.15 m³/g, or from 0.08 m³/g to 0.1 m³/g.

In one embodiment, the dry blend compositions or methods disclosed herein have a mercury removal capacity equal to or greater than that (within ±5% error) of a composition containing activated carbon only (e.g., at least 99% activated carbon, or 100% activated carbon). In comparing mercury removal capacity, the blend is compared with a composition containing activated carbon only, preferably the same activated carbon present in the blend. Removal capacity can be assessed with a fixed bed experiment in which a sorbent bed is subjected to a purge of mercury-containing gas having controlled mercury and SO₃ concentrations. As described in greater detail in Example 1, an average mercury removal capacity can be determined for the sorbent. A comparison can be performed on the basis of either total activated carbon injected or total sorbent injected.

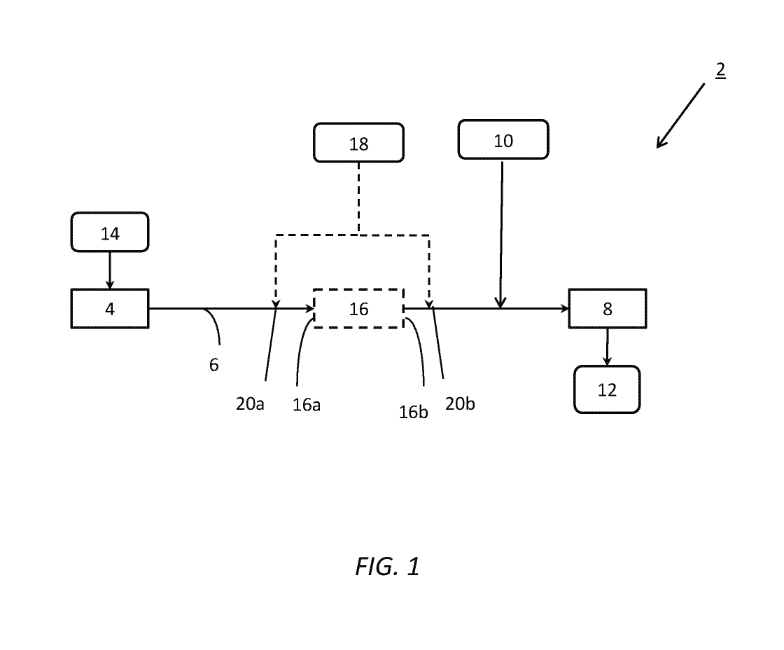

In one embodiment, the dry blend compositions or methods disclosed herein have a mercury removal performance equal to or greater than that (within ±2% error) of a composition containing activated carbon only (e.g., at least 99% activated carbon, or 100% activated carbon). Mercury removal performance can be tested in a system that generates a mercury-containing gas discharge. FIG. 1 is a flowchart showing the basic configuration of a power plant 2. Power plant 2 can be an operational power plant (e.g., via a slipstream), an experimental testing site, a pilot plant, or a lab scale model. Coal 14 is supplied to a boiler 4 containing water. Combustion of the coal 14 by boiler 4 heats the water to generate steam, causing flue gas to exit boiler 4 via the pathway indicated by arrow 6 through an economizer (not shown) positioned between the boiler and sorbent injection. Particulate sorbent 10 is injected downstream of boiler 4, resulting in adsorption of the mercury impurity onto sorbent 10. A particle collection device 8 separates spent sorbent 12 from the gas flow. The particle collection device 8 can comprise one or more devices known in the art, such as an electrostatic precipitator (ESP), fabric filter, or baghouse.

Optionally, power plant 2 can be configured to have an air preheater 16 positioned between boiler 4 and particle collection device 8, where air preheater 16 cools the flue gas exiting the economizer (not shown). Upstream of air preheater inlet 16a is termed the “hot side” whereas downstream of air preheater outlet 16b is termed “cold side” as temperatures can decrease by one or more hundred degrees Fahrenheit. Sorbent 10, although shown injected downstream of air heater 16, can be injected at the cold side or the hot side of air heater 16.

To determine the efficiency of mercury removal in the presence of SO₃, a source of SO₃ 18 for spiking controlled amounts into the flue gas is positioned either upstream 20a or downstream 20b of the air preheater 16.

The basic configuration of FIG. 1 can be configured in a variety of different ways. For example, the flue gas can be subjected to further treatment or purification as is known in the art.

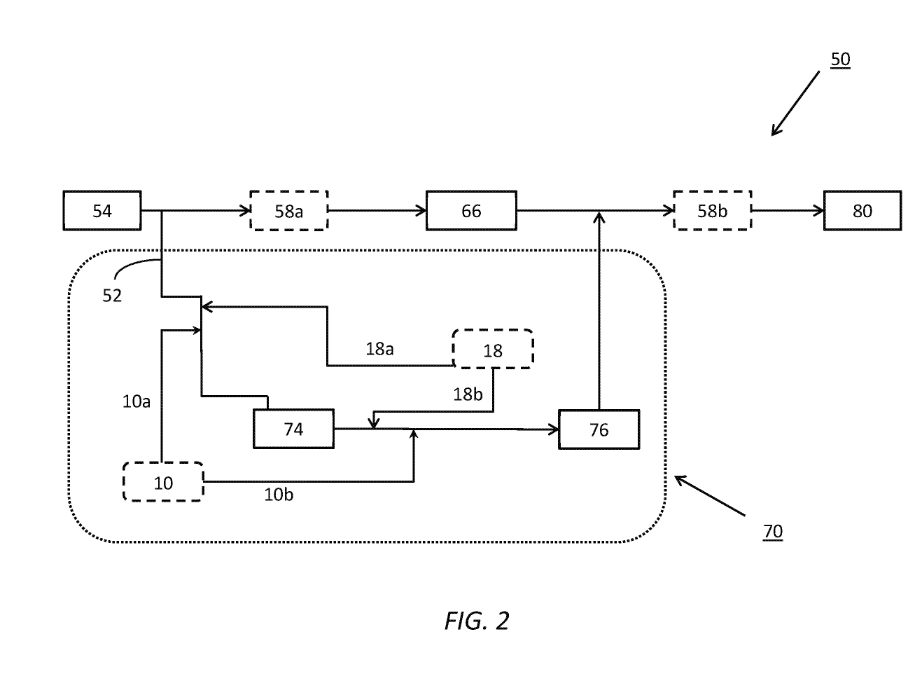

A power plant can be outfitted with a slipstream, configured for a portion of the flue gas to bypass the main path and allow testing to be performed on a smaller scale, as illustrated in FIG. 2. FIG. 2 schematically illustrates the configuration for a power plant at the Mercury Research Center at Gulf Power Company's Plant Crist Unit 5 in Pensacola, Fla. Power plant 50 comprises a boiler 54 from which flue gas is directed to an electrostatic precipitator (ESP) that can be positioned upstream (hot side ESP 58a) or downstream (cold side ESP 58b) of air preheater 66. Scrubber 80 is positioned further downstream of air heater 66 and or ESP 58b for removal of other pollutants.

For testing mercury removal in the presence of SO₃, unit 50 is outfitted with a slipstream 70 (inside dotted outline) containing bypass pathway 52 to generate flue gas having a temperature that is the average of the hot side and cold side gases. The flue gas entering slipstream 70 passes through air preheater 74, and particle collection device 76, which includes an ESP or baghouse. Sorbent 10 can be injected into inlets 10a (hot side) or 10b (cold side). Similarly, the injection of SO₃ 18 can occur on the hot side (18a) or cold side (18b). Mercury concentration can monitored before and after injection of sorbent 10 and SO₃ 18 upstream and downstream of particle collection device 76. Outlet concentration of mercury is measured with a continuous emission measuring system (e.g., Thermo Scientific™ continuous emissions monitoring system). Inlet concentration is measured using sorbent traps (EPA 30B). Sorbent traps are evaluated using an Ohio Lumex (RA-915AM Mercury Analyzer).

Another embodiment provides a method of mercury removal from a flue gas, comprising:

adding a dry blend sorbent composition to a flue gas, the composition comprising (or consisting essentially of, or consisting of):
a hydrated lime having a Ca(OH)₂ content of at least 94% by weight, the hydrated lime being present in an amount ranging from 1% to 40% by weight relative to the total weight of the composition; and
an activated carbon present in an amount of at least 60% by weight relative to the total weight of the composition.

Another embodiment provides a method of mercury removal from a flue gas, comprising:

adding activated carbon and a hydrated lime to a flue gas,

wherein the hydrated lime has a Ca(OH)₂ content of at least 94% by weight, and

wherein a mass ratio of activated carbon to hydrated lime added to the flue gas ranges from 6:4 to 95:5.

In the methods disclosed herein, the flue gas can be generated as a combusted fuel discharge from a number of industrial processes, e.g., power plants (e.g., coal-fired power plants), incinerators, and concrete kilns. In these processes, the discharged flue gas is suspected of containing impurities such as mercury. The sorbent can be added as one or more dry powders via injection as known in the art. The dry powder can be the dry blend. In one embodiment, the sorbent is added as dry powders comprising activated carbon and hydrated lime, which can be added separately to the flue gas either sequentially or simultaneously, e.g., co-injection. Other pollutants such as SO₂ and SO₃ can also be removed in this process. The adding or injecting can be performed at a number of injection prior to a particulate collection device (e.g., bags, filters, electrostatic precipitators), e.g., upstream or downstream of an air preheater. In one embodiment, the hydrated lime is injected initially to remove sulfur-containing impurities such as SO₃, or other impurities that can adsorb onto activated carbon. Subsequently, the activated carbon can be injected to a flue gas that is free of impurities that compete with mercury for activated binding sites, thereby providing an optimal surface for mercury adsorption.

In one embodiment, the mass ratio of activated carbon to hydrated lime added, injected, or co-injected into the flue gas ranges from 6:4 to 9:1, e.g., from 6:4 to 8:2, from 7:3 to 9:1, or from 7:3 to 8:2.

Another embodiment provides a method of mercury removal from a flue gas, in which a hydrated lime/activated carbon ratio is predetermined based on the SO₃ concentration in the flue gas. In one embodiment, the disclosed sorbent blends are effective at mercury removal at high SO₃ concentration and at low SO₃ concentration. One skilled in the art can adjust the hydrated lime/activated carbon depending on one or more factors such as the SO₃ concentration, type of activated carbon, mercury concentration.

Due to the effectiveness of hydrated lime in removing SO₃ impurities from a gas, a higher SO₃ concentration may require a higher ratio of hydrated lime relative to the activated carbon whereas reduced amounts of hydrated lime are required in the situation where the SO₃ concentration is low. The method can optimize the performance of the activated carbon during the mercury removal process. In certain situations, the hydrated lime/activated carbon ratio may be adjusted as the SO₃ concentration passes a certain threshold, e.g., 1 ppm, 3 ppm, or 5 ppm.

Accordingly, one embodiment provides a method of mercury removal from a flue gas, comprising:

determining an SO₃ concentration in the flue gas; and

adding a sorbent to the flue gas, wherein the sorbent comprises activated carbon and hydrated lime having a Ca(OH)₂ content of at least 94% by weight, and

wherein for an SO₃ concentration greater than 1 ppm, a mass ratio of activated carbon to hydrated lime added to the flue gas ranges from 6:4 to 8:2,

wherein for SO₃ concentration less than 1 ppm, a mass ratio of activated carbon to hydrated lime added to the flue gas ranges from 7:3 to 95:5.

Another embodiment provides a method of mercury removal from a flue gas, comprising:

determining an SO₃ concentration in the flue gas; and

adding a sorbent to the flue gas, wherein the sorbent comprises activated carbon and hydrated lime having a Ca(OH)₂ content of at least 94% by weight, and

wherein for an SO₃ concentration greater than 3 ppm, a mass ratio of activated carbon to hydrated lime added to the flue gas ranges from 6:4 to 8:2,

wherein for SO₃ concentration less than 3 ppm, a mass ratio of activated carbon to hydrated lime added to the flue gas ranges from 7:3 to 95:5.

Accordingly, one embodiment provides a method of mercury removal from a flue gas, comprising:

determining an SO₃ concentration in the flue gas; and

adding a sorbent to the flue gas, wherein the sorbent comprises activated carbon and hydrated lime having a Ca(OH)₂ content of at least 94% by weight, and

wherein for an SO₃ concentration greater than 5 ppm, a mass ratio of activated carbon to hydrated lime added to the flue gas ranges from 6:4 to 8:2,

wherein for SO₃ concentration less than 5 ppm, a mass ratio of activated carbon to hydrated lime added to the flue gas ranges from 7:3 to 95:5.

In one embodiment, when the SO₃ concentration is greater than a threshold value (e.g., 1 ppm, 3 ppm, or 5 ppm), a mass ratio of activated carbon to hydrated lime added to the flue gas ranges from 6:4 to 8:2, and when the SO₃ concentration is less than the threshold value (e.g., 1 ppm, 3 ppm, or 5 ppm), a mass ratio of activated carbon to hydrated lime added to the flue gas ranges from 7:3 to 95:5. In another embodiment, when the SO₃ concentration is greater than a threshold value (e.g., 1 ppm, 3 ppm, or 5 ppm), a mass ratio of activated carbon to hydrated lime added to the flue gas ranges from 6:4 to 8:2, and when the SO₃ concentration is less than the threshold value (e.g., 1 ppm, 3 ppm, or 5 ppm), a mass ratio of activated carbon to hydrated lime added to the flue gas ranges from 8:2 to 95:5. In yet another embodiment, when the SO₃ concentration is greater than a threshold value (e.g., 1 ppm, 3 ppm, or 5 ppm), a mass ratio of activated carbon to hydrated lime added to the flue gas ranges from 6:4 to 75:25, and when the SO₃ concentration is less than the threshold value (e.g., 1 ppm, 3 ppm, or 5 ppm), a mass ratio of activated carbon to hydrated lime added to the flue gas ranges from 75:25 to 95:5.

### EXAMPLES

All particle sizes for activated carbon were measured as liquid dispersions with an LS™ 13 320 or an LS™ 200 Laser Diffraction Particle Size Analyzer, both available from Beckman Coulter.

Unless indicated otherwise, mercury removal experiments were performed at either the Mercury Research Center (MRC) at Gulf Power Company's Plant Crist Unit 5 in Pensacola, Fla., or at the Emission Control Research Facility (ECRF) located within SASK Power's Poplar River Plant (Coronach, SK).

At the Mercury Research Center at Gulf Power Company's Plant Crist Unit 5 in Pensacola, Fla., mercury removal was performed on a slip stream of a coal fired power plant with a 75 MWe unit having a slip stream equivalent to 5 MWe. The unit is schematically illustrated in FIG. 2. Sorbent injection was performed on the cold side of the air heater (10b). The samples were fed to the unit with a calibrated gravimetric feeder. SO₃ concentration is reported in the tables below. Temperature at the hot side ranged from 675-690° F., at the ESP inlet (cold side) from 285-300° F., and at the ESP outlet at 270-280° F. The unit flue gas flow rate was roughly 20,000 actual cubic feet per minute (aCFM).

At the Emission Control Research Facility (ECRF) located within SASK Power's Poplar River Plant (Coronach, SK), mercury removal was performed on a slip stream of a coal fired power plant. The slip stream is equivalent to 0.5 MWe with an approximate flue gas flow rate of 2000 actual cubic feet per minute (aCFM). Particulate control was achieved with an electrostatic precipitator (ESP), and mercury removal across the ESP was measured by Tekran® 2537 CEMs. Sorbent injection was performed upstream of the electrostatic precipitator at a temperature of roughly 150° C., though the temperature may be moderated up to roughly 180° C. The ECRF does not have upstream or downstream of the air preheater (APH) injection ports because there is no APH in the slip stream unit. Instead, the desired temperature of flue gas is achieved by blending flue gas from upstream and downstream of the main plant APH.

### Example 1

This Example describes a fixed-bed mercury adsorption test in which the mercury adsorption capacity of activated carbon/lime blends were compared with a pure activated carbon sorbent in a fixed bed test.

Activated carbon (DARCO® Hg-LH activated carbon, Cabot Corporation, “Hg-LH”) was combined with lime to prepare an activated carbon/lime blend in a 75/25 ratio. The limes contained a Ca(OH)₂ concentration of at least 94% and are commercially available from Mississippi® Lime as Hydrated Lime HR (“HRH”) and Hydrated Lime FGT (“FGT”).

All mercury removal measurements were performed with a fixed-bed mercury adsorption system comprising: (1) an Hg⁰ gas delivery system (Thermo Scientific™ Model 81i Hg Calibrator) providing air flow having a 50 μg/m³ Hg⁰ concentration at a rate of 1.7 L/min; (2) a sorbent fixed-bed reactor containing 2.5 mg sorbent mixed and then packed in the reactor with 5 g sieved, −50 mesh sand from J. T. Baker); and (3) a Hg⁰ measurement system (Thermo Scientific™ Model 80i Hg Analyzer) that continuously monitors gas from the inlet and outlet of the fixed-bed reactor.

The fixed-bed was maintained at 3257 and the Hg⁰ loaded air flow was heated to 400° F. before entering the fixed-bed reactor. Any oxidized Hg present in the exiting air stream is converted to Hg⁰ by a thermal mercury converter, operated at a temperature of 1400° F., before being measured by the mercury analyzer. The temperatures were selected to simulate the flue gas PAC injection conditions.

Sulfur trioxide (5 ppm) was supplied to the system before the fixed-bed reactor by passing air with 1% SO₂ through a cylindrical catalyst-bed reactor maintained at 850° F.

The equilibrium adsorption capacity is defined as the amount of Hg⁰ removed by the sorbent after a full breakthrough is reached, when the outlet Hg⁰ concentration emerging from the fixed-bed equals the inlet Hg⁰ concentration. The breakthrough curve was plotted as the outlet Hg⁰ concentration of the sorbent bed against time. The difference between the inlet and outlet Hg⁰ indicates the Hg⁰ adsorbed by the sorbent over time. The cumulative Hg⁰ adsorbed is calculated by integrating the area under the inlet and outlet Hg⁰ curve using the trapezoidal rule. Dividing the cumulative Hg⁰ adsorbed by the sorbent mass generates the corresponding mercury adsorption capacity.

Table 1 shows the fixed bed data for the activated carbon/lime blends in comparison to activated carbon alone. The average mercury capacity is reported on the basis of total weight of activated carbon.

TABLE 1

| | Avg. Carbon Hg capacity |
|---|---|
| Sample | (μg/g) |
| Hg-LH | 331 |
| Hg-LH:FGT (75:25) | 367 |
| Hg-LH:HRH (75:25) | 505 |

It can be seen that on the fixed bed, the activated carbon/lime blends outperformed the pure activated carbon sorbent as indicated by the higher average Hg adsorption capacity.

### Example 2

This Example describes a comparison of different activated carbon/lime blends in which the Ca(OH)₂ concentration of the lime is varied.

Activated carbon (DARCO® Hg-LH EXTRA activated carbon, brominated, Cabot Corporation, “Hg-LH Extra”) was combined with lime to prepare an activated carbon/lime blend in a 70:30 ratio. The limes used in the 70:30 blends were: Mississippi® Lime having a Ca(OH)₂ concentration of at least 94% (Hydrated Lime HR, “HRH”); and standard hydrated limes purchased from Lien and Sons (“L&S”), The Home Depot (“HD” lime) and Lowe's (“Lowe's” lime), where L&S (92%), HD, and Lowe's limes all had Ca(OH)₂ concentrations of less than 94%.

The blends were tested for mercury removal at the MRC and compared with pure activated carbon (Hg-LH Extra). The SO₃ concentration was approximately 10 ppm.

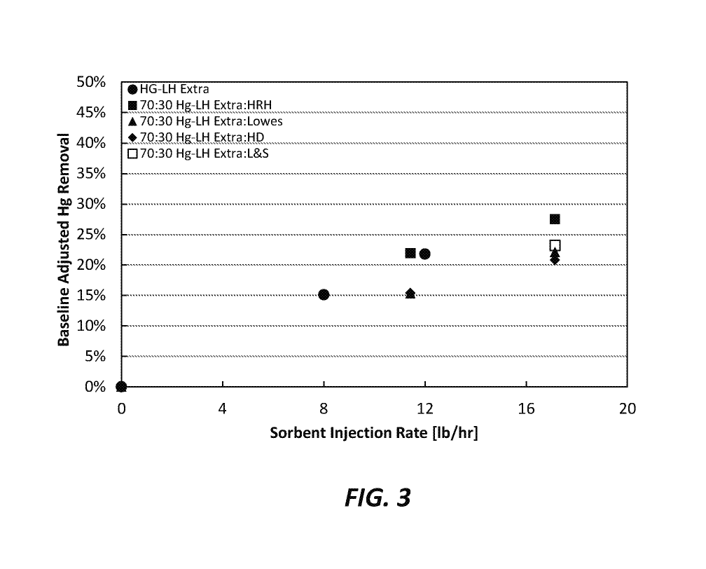

The mercury removal data (based off inlet Hg sorbent traps) is listed in Table 2 below and plotted in FIG. 3 (baselines adjusted Hg removal versus sorbent injection rate, lb/hr).

TABLE 2

| | Rate | Start | End | Removal at | Adjusted |
|---|---|---|---|---|---|
| | [lb/hr] | Time | Time | Inlet | Removal |
| Hg-LH Extra | 0 | 11:13 | 11:26 | 0.340 | 0.000 |
| (9.4 PPM SO3) | 8 | 11:33 | 11:43 | 0.491 | 0.151 |
| | 12 | 11:50 | 12:21 | 0.558 | 0.218 |
| 70:30 Hg-LH | 0 | 8:47 | 9:07 | 0.361 | 0.000 |
| Extra:Lowes | 11.4 | 9:13 | 9:22 | 0.514 | 0.153 |
| (10.0 PPM SO3) | 17.1 | 9:40 | 9:51 | 0.582 | 0.221 |
| 70:30 Hg-LH | 0.0 | 14:40 | 14:56 | 0.374 | 0.000 |
| Extra:HD | 11.4 | 15:14 | 15:25 | 0.528 | 0.154 |
| (9.4 PPM SO3) | 17.1 | 15:51 | 15:59 | 0.582 | 0.208 |
| 70:30 Hg-LH | 17.1 | 16:40 | 16:48 | 0.606 | 0.232 |
| Extra:L&S | | | | | |
| (9.4 PPM SO3) | | | | | |
| 70:30 Hg-LH | 11.4 | 12:28 | 12:51 | 0.559 | 0.000 |
| Extra:HRH | 17.1 | 12:56 | 13:17 | 0.615 | 0.056 |
| (9.4 PPM SO3) | | | | | |

It can be seen that the 70:30 AC/lime blend with HRH lime matched the performance of a pure activated carbon sorbent. In contrast, the 70:30 blends containing limes having a Ca(OH)₂ concentration less than 94% produced a worse mercury removal performance compared to the pure activated carbon sorbent.

### Example 3

This Example demonstrates the Hg-removal capacity of AC/lime blends in a 80:20 ratio, in which the lime is a hydrated lime having a Ca(OH)₂ content of at least 94%. The sorbents tested in this Example included activated carbon (DARCO® Hg-LH EXTRA activated carbon, Cabot Corporation, “Hg-LH Extra” or “AC”) blended with limes from Mississippi® Lime sold as Hydrated Lime HR (“HRH”) and Hydrated Lime FGT (“FGT”), from L′Hoist sold as Sorbacal® SP lime (“SP”), and hydrated lime from United States Lime & Minerals, Inc. (“US lime”), each lime having a high Ca(OH)₂ content of at least 94%.

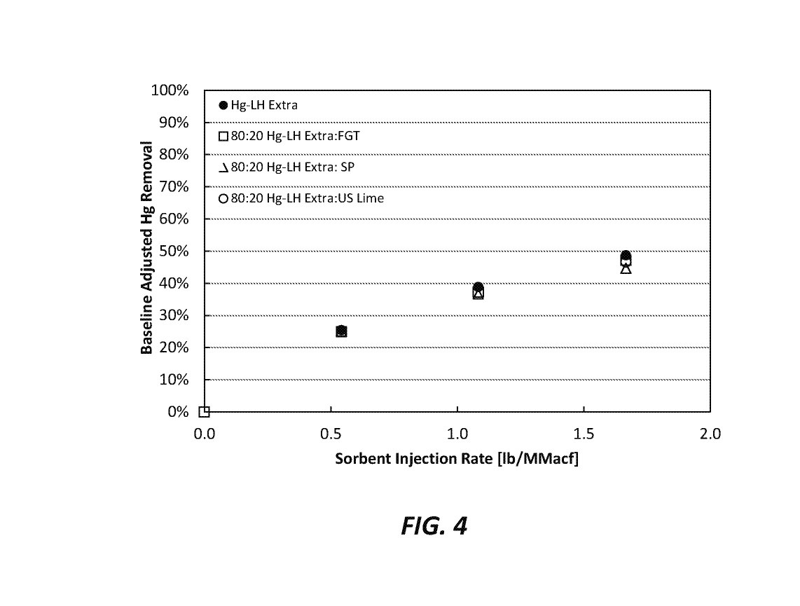

Mercury removal was performed at SASK at an SO₃ level of <1 ppm. Mercury removal data (based off inlet Hg sorbent traps) is listed in Table 3 below and plotted in FIG. 4 as baseline adjusted Hg removal versus sorbent injection rate [lb/MMacf].

TABLE 3

| | Rate | Rate | Start | End | Removal at | Adjusted |
|---|---|---|---|---|---|---|
| | [g/hr] | [lb/MMacf] | Time | Time | Inlet | Removal |
| Hg-LH | 30 | 0.54 | 10:15 | 10:27 | 0.213 | 0.254 |
| Extra | 59 | 1.08 | 10:35 | 10:47 | 0.347 | 0.388 |
| (AC) | 91 | 1.67 | 10:55 | 11:17 | 0.446 | 0.487 |
| 80:20 | 0 | 0.00 | 6:25 | 7:55 | −0.041 | 0.000 |
| AC:FGT | 30 | 0.54 | 8:15 | 8:37 | 0.208 | 0.249 |
| | 59 | 1.08 | 8:45 | 9:17 | 0.331 | 0.372 |
| | 91 | 1.67 | 9:25 | 9:47 | 0.431 | 0.472 |
| 80:20 | 30 | 0.54 | 13:35 | 13:57 | 0.210 | 0.251 |
| AC:SP | 59 | 1.08 | 14:15 | 14:47 | 0.325 | 0.366 |
| | 91 | 1.67 | 14:55 | 15:17 | 0.405 | 0.446 |
| 80:20 | 91 | 1.67 | 19:15 | 19:37 | 0.425 | 0.467 |
| AC:US | | | | | | |
| Lime | | | | | | |

It can be seen that each lime has a performance comparable to that of pure activated carbon due to its high Ca(OH)₂ content.

### Example 4

This Example compares the Hg-removal performance of activated carbon/lime blends based on the ratio of activated carbon to lime.

Blends of activated carbon/lime were prepared with ratios of 80:20, 70:30, 60:40, to 50:50, with DARCO® Hg-LH EXTRA activated carbon, Cabot Corporation (“Hg-LH Extra”) and Hydrated Lime HR (“HRH”) from Mississippi® Lime.

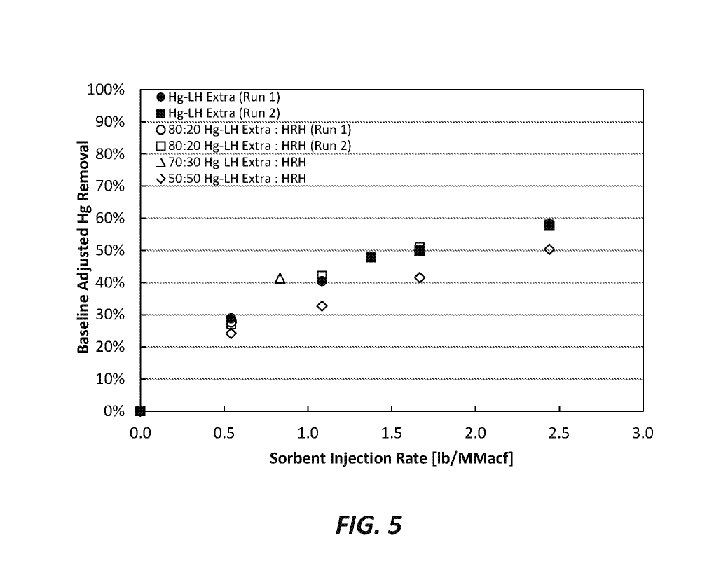

Mercury removal was performed at SASK at an SO₃ level of <1 ppm. Mercury removal data (based off inlet Hg sorbent traps) is listed in Table 4 below and plotted in FIG. 5 as baseline adjusted Hg removal versus sorbent injection rate [lb/MMacf].

TABLE 4

| | | Rate | | | | |
|---|---|---|---|---|---|---|
| | Rate | [lb/ | Start | End | Removal | Adjusted |
| | [g/hr] | MMacf] | Time | Time | at Inlet | Removal |
| Hg-LH Extra | 0 | 0.00 | 8:57 | 10:07 | −0.035 | 0.000 |
| (AC; Run 1) | 30 | 0.54 | 10:27 | 10:37 | 0.254 | 0.289 |
| | 59 | 1.08 | 10:45 | 10:57 | 0.369 | 0.405 |
| | 91 | 1.67 | 11:05 | 11:17 | 0.468 | 0.503 |
| | 133 | 2.44 | 11:25 | 11:35 | 0.546 | 0.581 |
| Hg-LH Extra | 75 | 1.38 | 10:00 | 10:13 | 0.478 | 0.479 |
| (Run 2) | 91 | 1.67 | 10:20 | 10:33 | 0.499 | 0.500 |
| | 133 | 2.44 | 10:40 | 10:53 | 0.577 | 0.577 |
| 80:20AC:HRH | 30 | 0.54 | 13:15 | 13:25 | 0.242 | 0.278 |
| (Run 1) | 91 | 1.67 | 13:52 | 14:25 | 0.463 | 0.499 |
| 80:20 | 0 | 0.00 | 7:24 | 8:13 | −0.001 | 0.000 |
| AC:HRH | 30 | 0.54 | 8:20 | 8:33 | 0.270 | 0.270 |
| (Run 2) | 59 | 1.08 | 8:43 | 8:53 | 0.421 | 0.421 |
| | 91 | 1.67 | 9:03 | 9:23 | 0.510 | 0.511 |
| | 133 | 2.44 | 9:30 | 9:53 | 0.580 | 0.581 |
| 70:30 AC:HRH | 45 | 0.83 | 10:32 | 10:42 | 9:34 | 0.413 |
| | 91 | 1.67 | 10:50 | 11:02 | 11:37 | 0.499 |
| 50:50 AC:HRH | 0 | 0.00 | 6:15 | 7:27 | −0.068 | 0.000 |
| | 30 | 0.54 | 7:45 | 8:05 | 0.174 | 0.242 |
| | 59 | 1.08 | 8:15 | 8:27 | 0.259 | 0.327 |
| | 91 | 1.67 | 8:35 | 8:47 | 0.347 | 0.415 |
| | 133 | 2.44 | 8:55 | 9:07 | 0.435 | 0.503 |

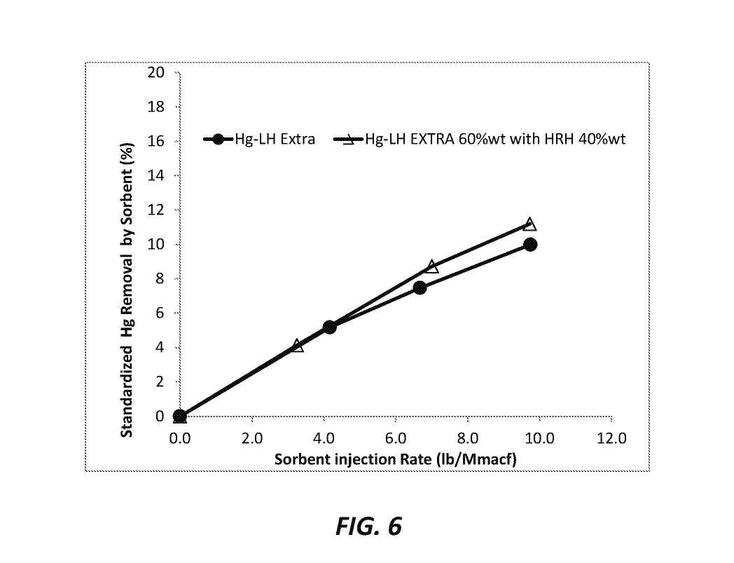

A separate comparison was made between a 60:40 blend of activated carbon (“Hg-LH extra”) and lime (“HRH”) versus pure activated carbon. Mercury removal was performed at MRC with an SO₃ concentration of 9.3 ppm. The mercury removal data is listed in Table 5 below and plotted in FIG. 6 as baseline adjusted Hg removal versus sorbent injection rate [lb/MMacf].

TABLE 5

| | | MRC | ESP | | | |
|---|---|---|---|---|---|---|
| | Injection | Inlet | Outlet | | | Carbon |
| | Rate | (HgT @ | (HgT @ | Total Hg | Standardized | Rate |
| | (lb/Mmacf) | 3% O2) | 3% O2) | Removal, % | Hg Removal, % | Corrected |
| 60:40 Hg-LH | 0.0 | 8.19 | 3.06 | 63 | 0 | 0 |
| Extra:Lime | 3.2 | 8.26 | 2.74 | 67 | 4 | 2 |
| | 7.0 | 8.19 | 2.34 | 71 | 9 | 4 |
| | 9.7 | 8.37 | 2.19 | 74 | 11 | 6 |
| Hg-LH Extra | 0.0 | 8.09 | 2.94 | 64 | 0 | |
| | 4.2 | 7.99 | 2.49 | 69 | 5 | |
| | 6.7 | 8.00 | 2.31 | 71 | 7 | |
| | 9.7 | 8.10 | 2.13 | 74 | 10 | |

It can be seen that the mercury removal performance of the 60:40 sorbent is comparable to that of the pure activated carbon.

The use of the terms “a” and “an” and “the” are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

1. A dry blend composition comprising:
a hydrated lime having a Ca(OH)₂ content of at least 94% by weight, the hydrated lime being present in an amount ranging from 1% to 40% by weight relative to the total weight of the composition; and
an activated carbon present in an amount of at least 60% by weight relative to the total weight of the composition.

2-18. (canceled)

19. A method of mercury removal from a flue gas, comprising:
adding a dry blend sorbent composition to a flue gas, the composition comprising:
a hydrated lime having a Ca(OH)₂ content of at least 94% by weight, the hydrated lime being present in an amount ranging from 1% to 40% by weight relative to the total weight of the composition; and
an activated carbon present in an amount of at least 60% by weight relative to the total weight of the composition.

20. (canceled)

21. A method of mercury removal from a flue gas, comprising:
determining an SO₃ concentration in the flue gas; and
adding a sorbent to the flue gas, wherein the sorbent comprises activated carbon and hydrated lime having a Ca(OH)₂ content of at least 94% by weight, and
wherein for an SO₃ concentration greater than 1 ppm, a mass ratio of activated carbon to hydrated lime added to the flue gas ranges from 6:4 to 8:2, and
wherein for SO₃ concentration less than 1 ppm, a mass ratio of activated carbon to hydrated lime added to the flue gas ranges from 7:3 to 95:5.

22. (canceled)

23. (canceled)

24. The method of claim 19, wherein the hydrated lime has a d₅₀ particle size distribution ranging from 1-10 μm.

25. (canceled)

26. (canceled)

27. The method of claim 19, wherein the hydrated lime has a surface area of at least 20 m²/g.

28. (canceled)

29. The method of claim 19, wherein the hydrated lime has a pore volume of at least 0.06 m³/g.

30. (canceled)

31. The method of claim 19, wherein the hydrated lime has a MgO concentration of less than 3% by weight.

32. The method of claim 19, wherein the hydrated lime has a Mg(OH)₂ concentration of less than 3% by weight.

33. The method of claim 21, wherein the hydrated lime has a d₅₀ particle size distribution ranging from 1-10 μm.

34. The method of claim 21, wherein the hydrated lime has a surface area of at least 20 m²/g.

35. The method of claim 21, wherein the hydrated lime has a pore volume of at least 0.06 m³/g.

36. The method of claim 21, wherein the hydrated lime has a MgO concentration of less than 3% by weight.

37. The method of claim 21, wherein the hydrated lime has a Mg(OH)₂ concentration of less than 3% by weight.
